(19) United States
(12) Patent Application Publication
(10) Pub. No.: US 2021/0184887 A1
(43) Pub. Date: Jun. 17, 2021

(54) LABEL BASED ISOCHRONOUS CONNECTION UPDATE

(71) Applicants: Harish Balasubramaniam, San Jose, CA (US); Daniel Cohn, Raanana (IL); Magnus Eriksson, Portland, OR (US); Oren Haggai, Kefar Sava (IL); Robert Hughes, Tualatin, OR (US); Idan Zalitzky, Raanana (IL)

(72) Inventors: Harish Balasubramaniam, San Jose, CA (US); Daniel Cohn, Raanana (IL); Magnus Eriksson, Portland, OR (US); Oren Haggai, Kefar Sava (IL); Robert Hughes, Tualatin, OR (US); Idan Zalitzky, Raanana (IL)

(21) Appl. No.: 17/166,850

(22) Filed: Feb. 3, 2021

Related U.S. Application Data
(60) Provisional application No. 62/983,088, filed on Feb. 28, 2020.
(60) Provisional application No. 62/969,497, filed on Feb. 3, 2020.

(51) Int. Cl. H04L 12/40; H04L 29/06; H04W 76/10; H04W 28/20

(52) U.S. Cl. CPC H04L 12/4011; H04L 12/40058; H04L 12/40065; H04W 56/005; H04W 76/10; H04W 28/20; H04L 69/22

(57) ABSTRACT

This disclosure describes systems, methods, and devices related to label based isochronous connection update. A central Bluetooth low energy (BLE) device may send a plurality of labels to a peripheral BLE device during a setup of a BLE communication to notify the peripheral BLE device of one or more labels to be used during the BLE communication. The central BLE device may determine a channel variation between the central BLE device and the peripheral BLE device. The central BLE device may send a first label to the peripheral BLE device to indicate an isochronous (ISO) parameter update that will occur at a first time offset based on the channel variation. The central BLE device may implement the isochronous parameter update at the first time offset based on the channel variation.

### CROSS-REFERENCE TO RELATED APPLICATIONS

This application is related to and claims priority to U.S. Provisional Patent Application No. 62/983,088, filed Feb. 28, 2020, and to U.S. Provisional Patent Application No. 62/969,497, filed Feb. 3, 2020, the disclosures which are hereby incorporated herein by reference in their entirety.

### TECHNICAL FIELD

This disclosure generally relates to systems and methods for wireless communications and, more particularly, to label based isochronous connection update.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for label based isochronous connection update, in accordance with one or more example embodiments of the present disclosure.

FIGS. 2-8 depict illustrative schematic diagrams for label based isochronous connection update, in accordance with one or more example embodiments of the present disclosure.

FIGS. 9-10 depict illustrative schematic diagrams for silence suppression, in accordance with one or more example embodiments of the present disclosure.

FIG. 11 illustrates a flow diagram of illustrative process for an illustrative label based isochronous connection update system, in accordance with one or more example embodiments of the present disclosure.

FIG. 12 illustrates a functional diagram of an exemplary communication station that may be suitable for use as a user device, in accordance with one or more example embodiments of the present disclosure.

FIG. 13 illustrates a block diagram of an example machine upon which any of one or more techniques (e.g., methods) may be performed, in accordance with one or more example embodiments of the present disclosure.

FIG. 14 is a block diagram of a radio architecture in accordance with some examples.

FIG. 15 illustrates an example front-end module circuitry for use in the radio architecture of FIG. 14, in accordance with one or more example embodiments of the present disclosure.

FIG. 16 illustrates an example radio IC circuitry for use in the radio architecture of FIG. 14, in accordance with one or more example embodiments of the present disclosure.

FIG. 17 illustrates an example baseband processing circuitry for use in the radio architecture of FIG. 14, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Connected Isochronous Stream (CIS) and broadcast isochronous stream (BIS) form the fundamental building blocks for supporting BLE Audio. Once the CIS or BIS is established, there currently exists no mechanism to update the Stream connection parameters in middle of the lifetime of a connection. Currently, isochronous connection (referred to herein as ISO) has no support for updating the connection parameters in the middle of an active connection. As will be discussed below this could be a handicap when channel conditions vary between bad and good conditions. This disclosure proposes a mechanism to update the connection parameters of an established CIS and BIS. It also proposes to combine multiple updates (like PHY, Burst Number, Flush Timeout, etc.) into a single operation in order to do efficient connection updates.

When channel conditions vary between good to bad, different connection parameters may yield optimal performance to reduce undelivered packets, minimize radio on time, facilitate coexistence with other technologies.

With future plans to add High Data Rate PHYs and support longer payloads (Hyper-length) than 251 bytes, a static set of connection parameters and PHY settings will not lead to optimal performance in all conditions.

A solution to the problem has to satisfy the following requirements:
Isochronous parameter update may involve both PHY settings and Connection parameter (e.g., for CIS, they are Burst Number, Flush Timeout, Number of Sub Events, Max PDU Size, sub-event intervals).
Solution should not depend on real-time ACL Control procedures as usually the ACL connection operates on a longer interval than associated CIS.
Should preferably use the CIS or BIS directly to indicate updates to the Stream parameters. It should not consume too much airtime to specify the parameters (e.g. LL_CIS_REQ used to configure CIS is 35 bytes in length) as the ISO and Sub-event intervals may already be time constrained. ISO refers to isochronous connection.
Time taken to PHY Update and Connection Update in sequence will consume a lot of time. Hence a mechanism to perform simultaneous PHY and Connection Update within one or few ISO Connection events is essential
Solution should apply to Broadcast streams (BIS) if channel conditions are detected via alternate mechanisms (as BIS do not have a feedback channel from the peripheral BLE devices).

Previous approaches to do change the link related parameter update is to have separate Link Layer Control Signaling procedures initiated on demand over an ACL connection. There are separate procedures to do 1) PHY Update 2) Connection update 3) Power Control etc. Each Link Layer Control procedure in LE has to be executed in sequence. Hence it would consume a lot of time if each of these involved future instants when the update actually happens. These procedures were also initiated on low energy (LE) access control list (ACL) which may have a longer connection interval and hence take longer time to complete.

The event intervals for CIS and BIS are much closely packed than associated ACL. There is a need for a quick and rapid connection update mechanism that makes use of inline signaling via CIS or BIS. It should also not consume airtime in terms of too many bytes.

When silence suppression is used in applications, the audio application in the side where silence is detected (far end) indicates this to the audio application in the other end (near end), and the near end application generates comfort noise, so the user will not think the call has been disconnected.

When the near end is using a Bluetooth headset, the near end application transmits the generated comfort noise as an audio stream toward the Bluetooth adaptor, which in turn transmits it via Bluetooth audio profile (HFP or low energy (LE) audio) toward the headset. It should be understood that a reference to LE means it is a BLE.

Transmitting and receiving the comfort noise over the Bluetooth air interface increases power consumption at the platform and the headset so the battery life is decreased for both.

In addition, the Bluetooth traffic increases network load at the 2.4 GHz spectrum which reduces Wi-Fi and Bluetooth performance for the PC/mobile as well as for other stations in the vicinity.

When silence suppression is not used, silent audio is transmitted over the Bluetooth air interface with a similar impact on power and network performance.

These are very common use cases and therefore reducing power consumption and increasing battery life in these scenarios is essential for PC, phone and headset vendors and end users.

Previous solutions transmit comfort noise or silence over the Bluetooth logical transport interface. In classic Bluetooth the logical transport is eSCO (extended synchronous connection oriented); while in LE, the logical transport is CIS (Connected Isochronous Stream).

Transmitting a phone-quality audio stream over Bluetooth typically requires 17% Bluetooth ratio on time for the stations for HFP with eSCO logical transport when using a single ear bud (or proprietary 2^{nd} ear bud which only sniffs to the first ear bud). In LE Audio technology using CIS logical transport, the radio on time for single ear bud is 6%, and 13% for two earbuds. When the mechanism described in this disclosure is used, radio on time is not used while the voice session is in silence state, so the air time can be used by the PC/mobile or by other stations for Wi-Fi/BT traffic.

Typical power consumption for a Bluetooth controller for an active voice session is in the order of 60 mw for HFP with eSCO logical transport (full platform power can reach ˜500 mW).

Example embodiments of the present disclosure relate to systems, methods, and devices for label based isochronous connection update.

A central Bluetooth low energy (BLE) may send a plurality of labels to a peripheral BLE device during a setup of a BLE communication to notify the peripheral BLE device of one or more labels to be used during the BLE communication. The central BLE device may determine a channel variation between the central BLE device and the peripheral BLE device. The central BLE device may send a first label to the peripheral BLE device to indicate an isochronous (ISO) parameter update that will occur at a first time offset based on the channel variation. The central BLE device may implement the isochronous parameter update at the first time offset based on the channel variation.

In one or more embodiments, each label may comprise changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

In one or more embodiments, the central BLE device may send an ISO protocol data unit (PDU) to the peripheral BLE device, wherein the ISO protocol data unit (PDU) comprises the first label.

In one or more embodiments, the ISO PDU may comprise a header, wherein the header comprises a header bit associated with a label field. The header bit may be set to 1 to indicate a presence of the label field. The header bit may be set to 0 to indicate an absence of the label field.

In one embodiment, a label based isochronous connection update system may facilitate a Label based Isochronous Connection Update mechanism. Each Label (4 bits allowing up to ˜15 labels) defines a diverse set of connection related parameters and a Label may be defined for different channel conditions (good, bad, worst, etc.). Once connected isochronous channels (CIS) or BIS is established, the device may simply use these Labels in the header of a CIS or BIS protocol data unit (PDU) (along with an instant in future where the change takes effect) to indicate a change to the connection parameters.

The Label based approach to effectively combine multiple parameter update procedures is unique and never attempted before.
By using concept of pre-defined Labels, this feature allows a quick and rapid connection update without consuming airtime in audio packets.
Under bad channel conditions, this feature allows a device to adjust the PHY and connection related parameters. This leads to robust and improved LE Audio performance in diverse conditions.
By using the CIS or BIS PDU header directly to initiate the connection update, this leads to much faster updates and hence better listening quality for end customers.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

Example embodiments of the present disclosure relate to systems, methods, and devices for a mechanism to efficiently support silence suppression in Bluetooth audio profiles.

In some embodiments, this mechanism applies to audio applications running on PC or mobile platforms where a Bluetooth headset is used.

In one embodiment, a silence suppression system may facilitate that the near end audio application signal to the Bluetooth controller when the receiving stream is in silence suppression state. When this happens, the Bluetooth controller should notify the Bluetooth headset that the stream is in silence suppression state and stop sending Bluetooth voice packets towards the headset (eSCO for HFP or LE CIS for LE audio). The headset should then generate the comfort noise locally toward the user, based on a comfort noise pattern provided by the PC/mobile in the last audio packet before silence start was, or based on a local generation algorithm.

In one or more embodiments, a silence suppression system may facilitate that both the Bluetooth controller and the headset implement silence detection. When silence is continuously detected for a given interval (e.g. one second), the same mechanism as described above should be invoked.

The value may be power consumption reduction and coexistence performance improvement, which will in turn improve user experience and satisfaction.

For example, when silence is detected in both directions, Bluetooth power consumption using the silence suppression system will be 2-6 mw (˜90-95% lower than before).

Observations show that in typical voice over IP (VOIP) voice calls the application is in silence state in one direction between 25 and 50% of the call, and in both directions between 5 and 25% of the call. This shows significant power and air time saving potential.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

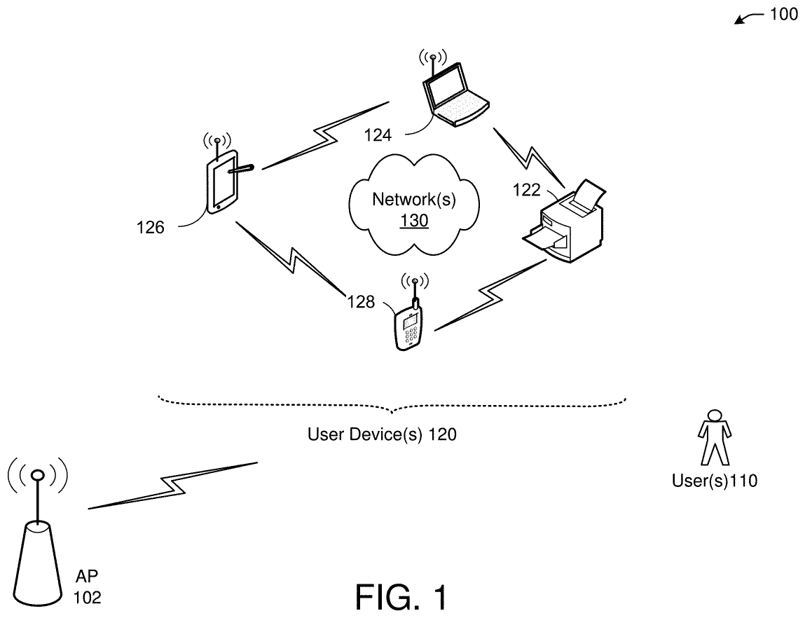

FIG. 1 is a network diagram illustrating an example wireless network 100 of a label based isochronous connection update system, according to some example embodiments of the present disclosure. Wireless network 100 can include one or more user devices 120 (e.g., 122, 124, 126, or 128), which may communicate in accordance with wireless standards, such as Bluetooth and the IEEE 802.11 communication standards, over network(s) 130.

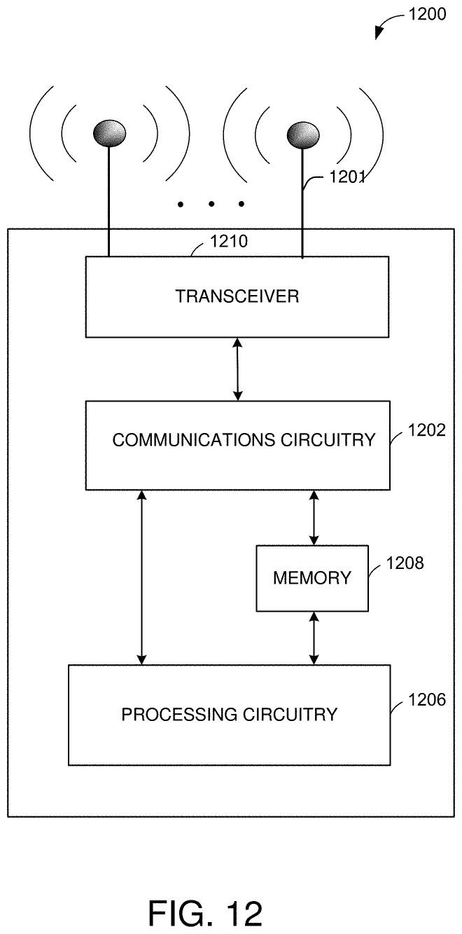

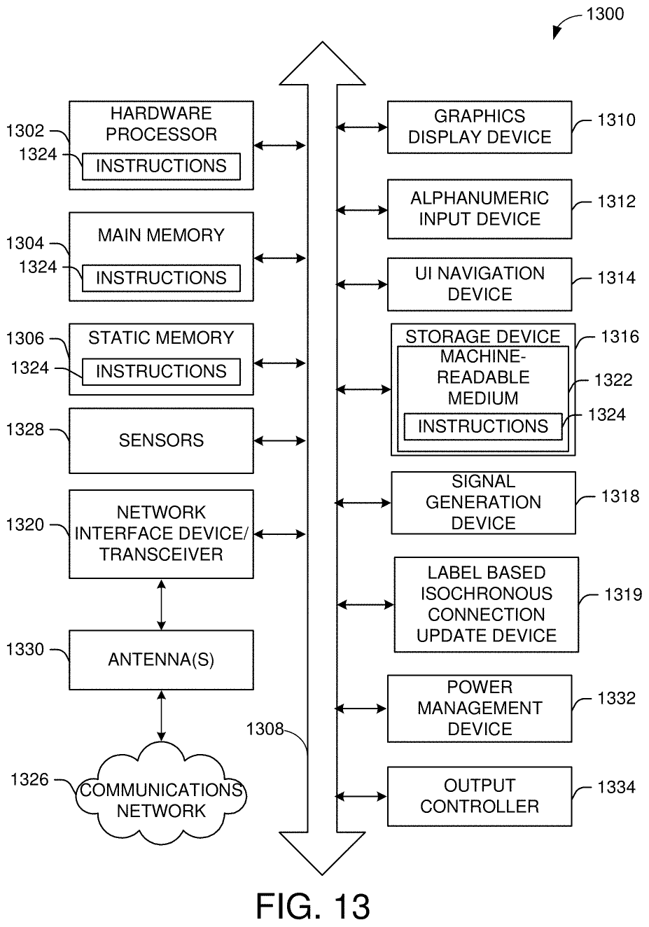

In some embodiments, the user devices 120 can include one or more computer systems similar to that of the functional diagram of FIG. 12 and/or the example machine/system of FIG. 13.

One or more illustrative user device(s) 120 may be operable by one or more user(s) 110. The user device(s) 120 (e.g., 122, 124, 126, or 128) may include any suitable processor-driven user device including, but not limited to, a desktop user device, a laptop user device, a server, a router, a switch, an access point, a smartphone, a tablet, a wearable wireless device (e.g., a bracelet, a watch, glasses, a ring, etc.), and so forth.

Any of the user devices 120 (e.g., 122, 124, 126, or 128) may be configured to communicate with each other and any other component of the wireless network 100 directly and/or via the one or more communications networks 130, wirelessly or wired.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the communications networks 130 may include, but not be limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user devices 120 (e.g., 122, 124, 126, or 128) may include one or more communications antennas. Communications antennas may be any suitable type of antenna corresponding to the communications protocols used by the user device(s) 120. Some non-limiting examples of suitable communications antennas include Bluetooth antennas, Wi-Fi antennas, IEEE 802.11 family of standards compatible antennas, directional antennas, non-directional antennas, dipole antennas, folded dipole antennas, patch antennas, MIMO antennas, or the like. The communications antenna may be communicatively coupled to a radio component to transmit and/or receive signals, such as communications signals, to and/or from the user devices 120 (e.g., 122, 124, 126, or 128).

Any of the user devices 120 (e.g., 122, 124, 126, or 128) may include any suitable radio and/or transceiver for transmitting and/or receiving radio frequency (RF) signals in the bandwidth and/or channels corresponding to the communications protocols utilized by any of the user device(s) 120 to communicate with each other. The radio components may include hardware and/or software to modulate and/or demodulate communications signals according to pre-established transmission protocols. The radio components may further have hardware and/or software instructions to communicate via one or more Bluetooth, Wi-Fi, and/or Wi-Fi Direct protocols, as standardized by the Bluetooth and the Institute of Electrical and Electronics Engineers (IEEE) 802.11 standards.

In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Some embodiments may be used in conjunction with devices and/or networks operating in accordance with existing. Wireless Fidelity (WiFi) Alliance (WFA) Specifications, including Wi-Fi Neighbor Awareness Networking (NAN) Technical Specification (e.g., NAN and NAN2) and/or future versions and/or derivatives thereof, devices and/or networks operating in accordance with existing WFA Peer-to-Peer (P2P) specifications and/or future versions and/or derivatives thereof, devices and/or networks operating in accordance with existing Wireless-Gigabit-Alliance (WGA) specifications (Wireless Gigabit Alliance, Inc WiGig MAC and PHY Specification) and/or future versions and/or derivatives thereof, devices and/or networks operating in accordance with existing IEEE 802.11 standards and/or amendments (e.g., 802.11b, 802.11g, 802.11n, 802.11ac, 802.11ax, 802.11ad, 802.11ay, 802.11az, etc.).

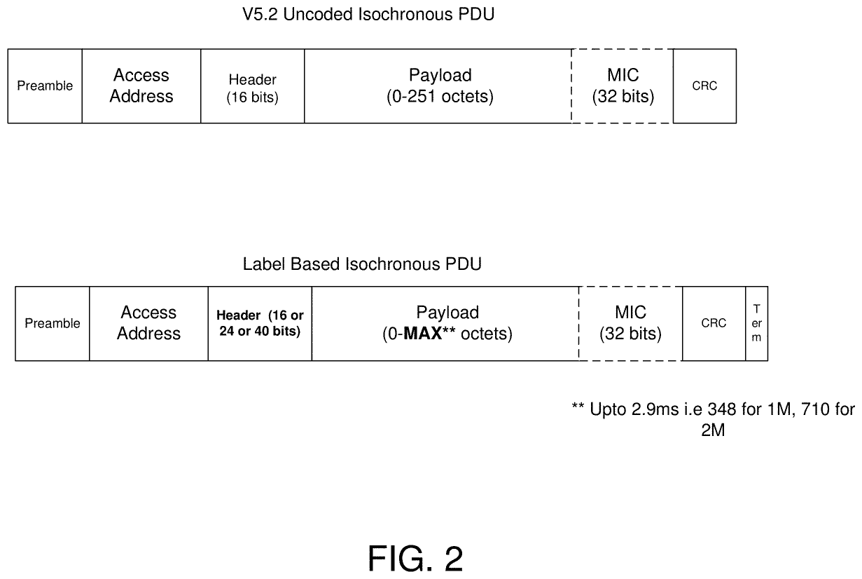

FIGS. 2-8 depict illustrative schematic diagrams for label based isochronous connection update, in accordance with one or more example embodiments of the present disclosure.

In one or more embodiments, a label based isochronous connection update system may facilitate a Label Based Isochronous Connection Update mechanism. Each Label is assigned 4 bits and up to 15 unique Labels can be defined per CIS connection. The characteristics of a Label include following: PHY, Burst Number (BN), Flush Timeout (FT), Number of Sub Events (NSE), ISO interval, Sub-Event Interval, Max PDU Size, Tx Power (optional). It should be understood that M refers to modulation at the PHY layer. For example, 1M means a first modulation and a 2M means a second modulation that is different than the first modulation.

An Example of a Label based parameter assignment is shown below:

| Channel | Label | |
|---|---|---|
| type | id | Parameters |
| Good | 1 | 2M, BN = 1, FT = 1, NSE = 2, ISO Interval 7.5 ms, |
| | | Sub-event interval .75 ms, PDU 117 bytes |
| Medium | 2 | 2M, BN = 1, FT = 1, NSE = 4, ISO Interval 7.5 ms, |
| | | Sub-event interval .75 ms, PDU 117 bytes |
| Worse | 3 | 1M, BN = 1, FT = 1, NSE = 2, ISO Interval 7.5 ms, |
| | | Sub-event interval 1.5 ms, PDU 117 bytes |

Packet format modifications for CIS and BIS:

The BLE standard (v5.2) Isochronous PDU format and changes to the v5.2 format to incorporate the Label based Connection Update scheme is shown in FIG. 2.

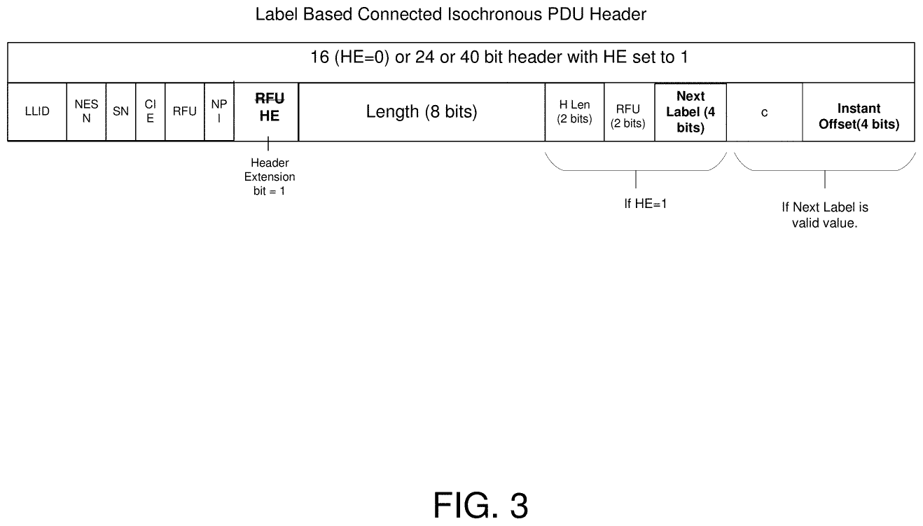

The changes to the CIS PDU Header by using the Header Extension (HE) bit to incorporate both the Hyper Length extension (increase length of PDU from 8 bits to 10 bits) and the Label scheme is shown in FIG. 3.

One of the RFU bits from v5.2 CIS Header is reused as Header Extension bit (HE). When HE=1, the additional byte includes the 4-bit ‘Next Label’ field. This field is set to a valid value from 1 to 15 only when a connection update is pending. Otherwise it is set to zero. When the ‘Next Label’ is set to a valid value, the Instant Offset field is set to the CIS Event Counter value which is at least 1 connection event in future or more.

Note: Instant Offset (4 bits) is used instead of a 16-bit event counter. This is because the field is part of the PDU header that a Controller may update every event rather than part of a payload.

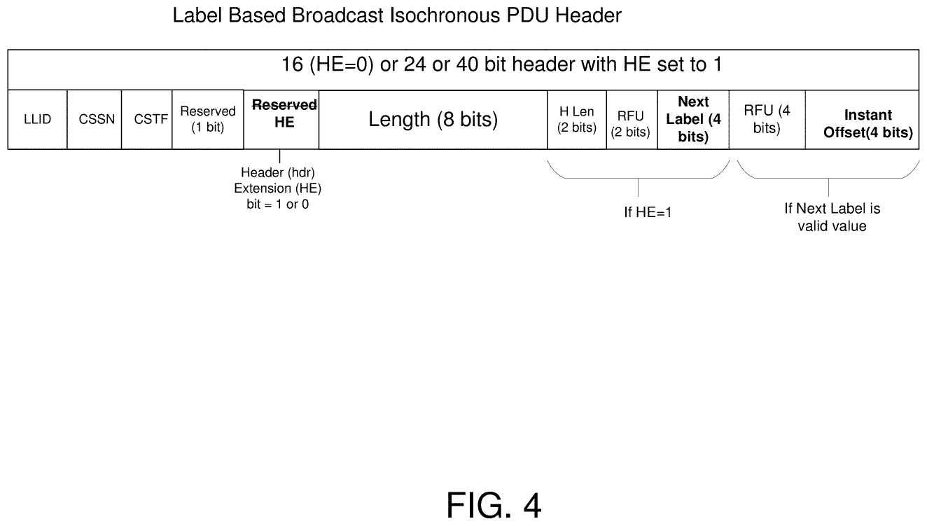

The corresponding change for BIS PDU Header is shown in FIG. 4.

Message sequence chart and Timeline diagram for Label based Connection Update:

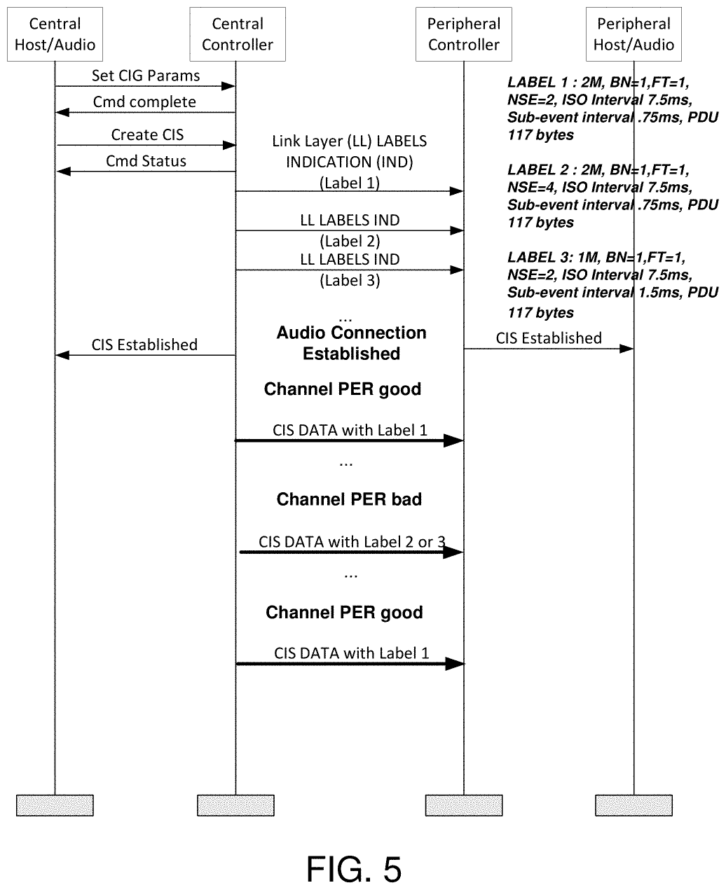

The message sequence chart for how a central BLE device and a peripheral BLE device can establishing a CIS connection may make use of the Label based Connection Update scheme is shown in FIG. 5.

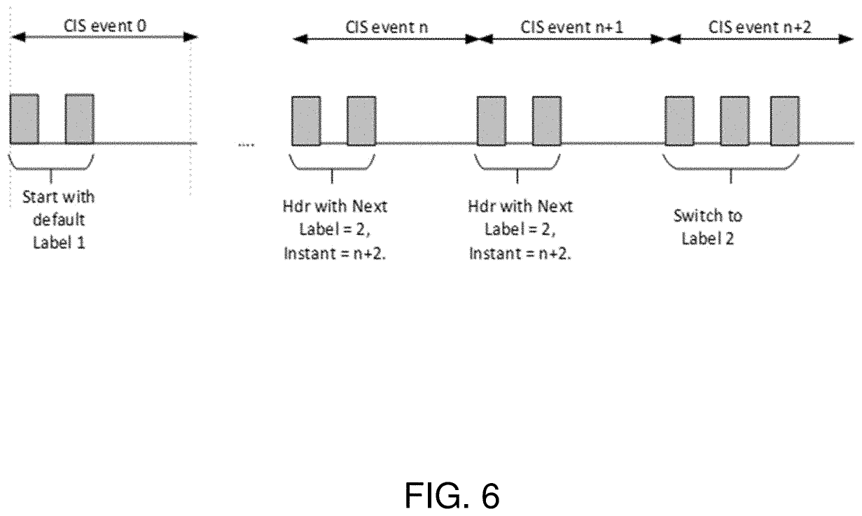

An example of the packet timeline showing a Label based Connection Update starting at CIS event n is shown in FIG. 6. At CIS event n+2, the switch to parameters defined by Label 2 is achieved. This shows an example of switching from Label 1 (2M, BN=1, FT=1, NSE=2) to Label 2 (2M, BT=1, FT=1, NSE=3).

Using Labels for miscellaneous items like Transmit Power updates:

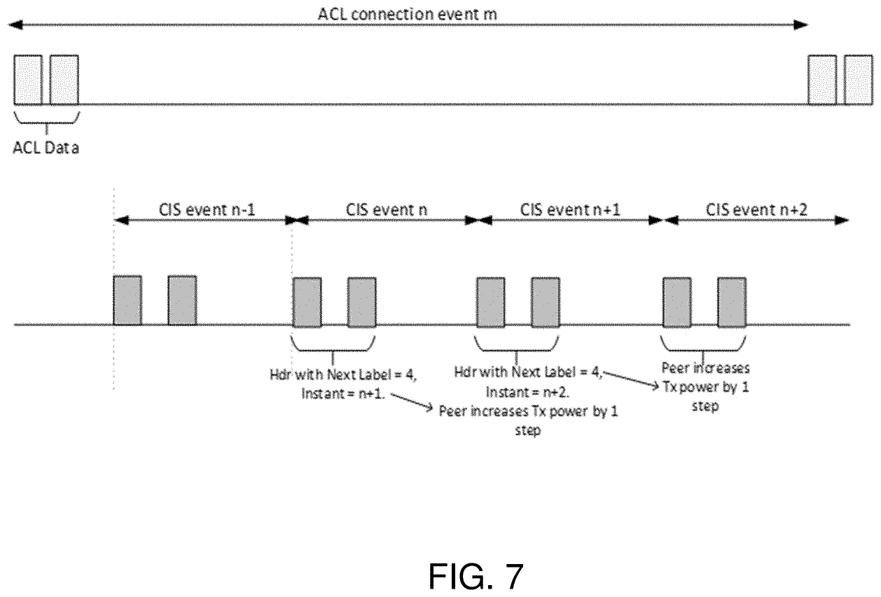

The Labels cannot only be used for PHY and Connection parameter updates, it can also be used for optimally executing miscellaneous control procedures like Transmit Power update requests directly via CIS. See an example below where executing Label based transmit power update requests directly via CIS is much faster than doing it via ACL signaling. This will lead to better link performance as the device can respond faster to channel conditions, as shown in FIG. 7. FIG. 7 shows an example label based transmit power updates directly via CIS (note the long ACL event intervals).

Label based updates for Broadcast (BIS):

For BIS broadcast connection, there is no feedback channel for the Broadcaster from the receiving devices that could help assess channel conditions. But a device may collect information on channel conditions by other means (left to implementation). The characteristics defining each Label to be used for BIS can also be shared with the receiving devices via periodic advertising (ACAD field of AUX_SYNC_IND). A new ACAD type ‘BigInfoLabel’ has to be defined.

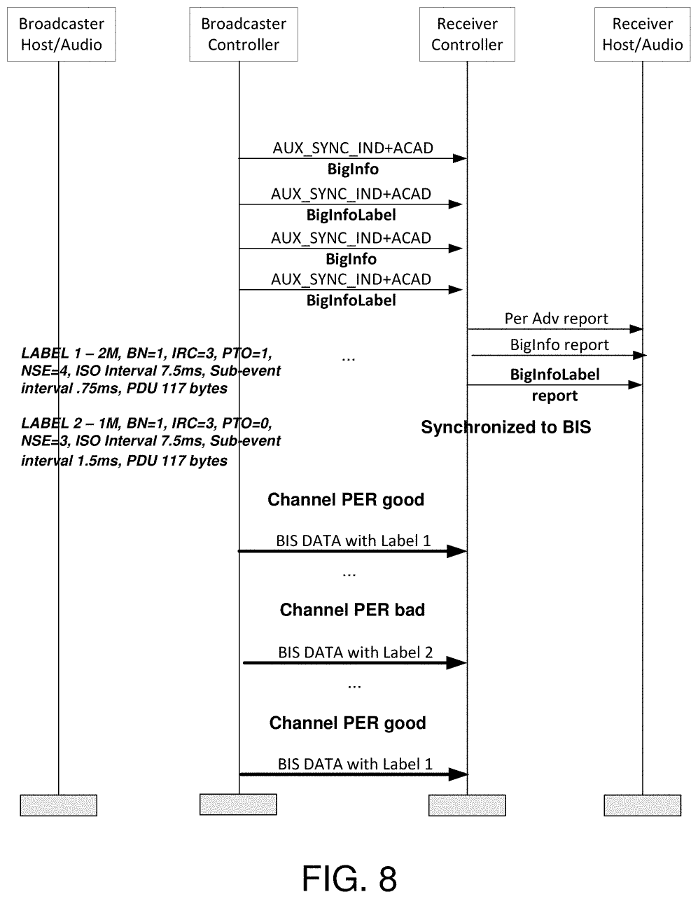

An example MSC for the use of Label based updates on a BIS is shown in FIG. 8.

In one or more embodiments, a label based isochronous connection update may achieve quick and rapid Isochronous Connection Updates directly via the Isochronous streams itself. Many more creative uses of Label based updates (e.g Transmit power updates) are also expected in future. This will help significantly improve link quality and power consumption for products and wider Bluetooth LE Audio ecosystem. It is understood that the above descriptions are for purposes of illustration and are not meant to be limiting.

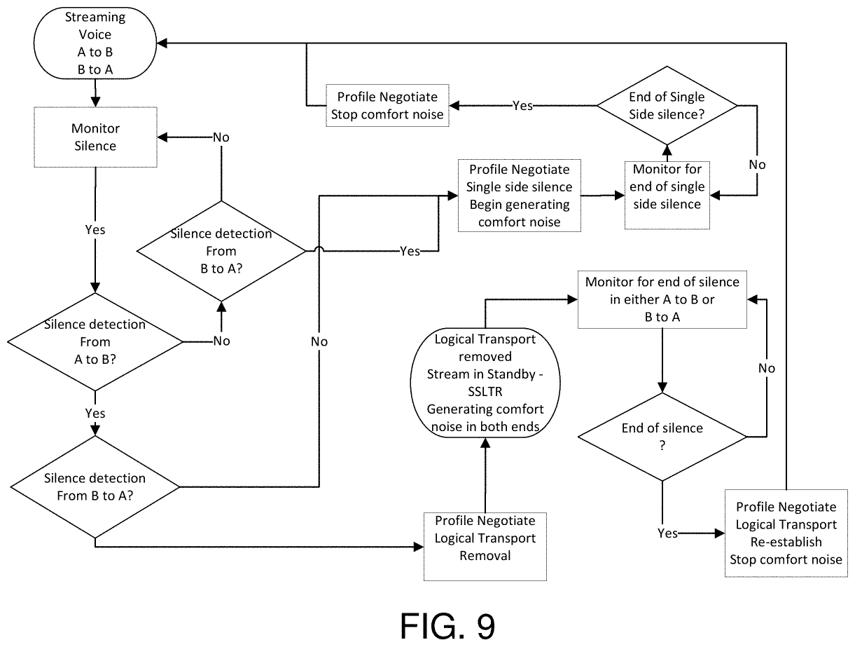

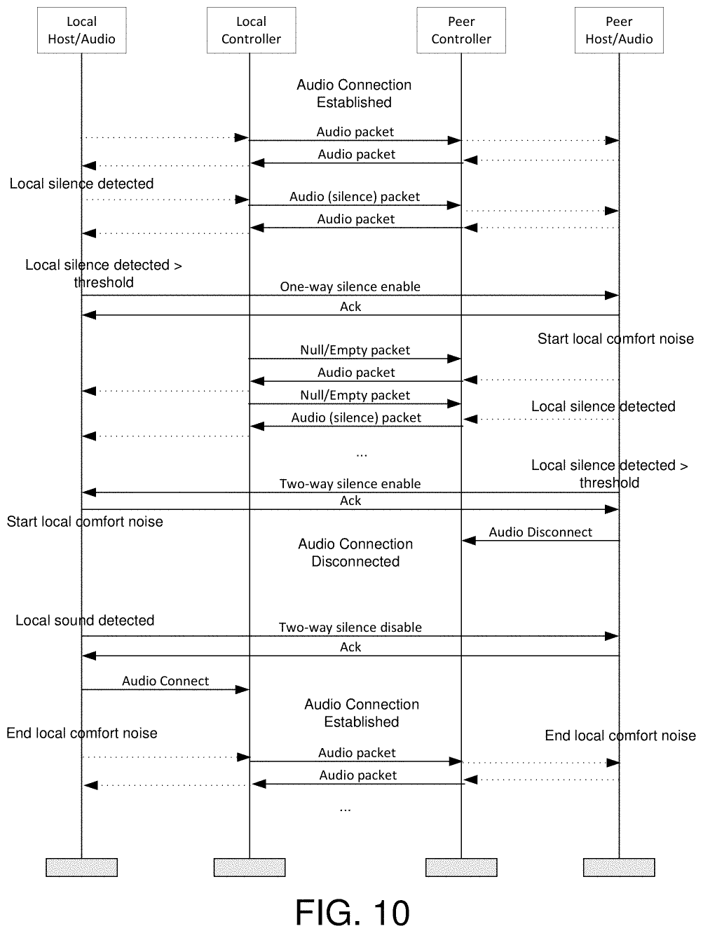

FIGS. 9-10 depict illustrative schematic diagrams for silence suppression, in accordance with one or more example embodiments of the present disclosure.

In one or more embodiments, a silence suppression system may facilitate the following steps:
Silence start detection (either from application or from local detection at BT controller/headset).
Sending silence control message, remove the stream, and move to a special silence state.
Locally generate comfort noise based on last packet or local generation algorithm.
Silence end detection by monitoring silence period and detect when silence condition ended.
Adding the stream back when silence period is ended, stop local comfort noise
In case only a single side silence is detected then the following steps are taken.
Send a profile protocol message to generate comfort noise at far end.
Stop stream in one direction (send empty packets).
Monitor for end of silence.
Once silence is over, send a profile protocol message to stop comfort noise at far end.
Continue streaming.

A greater power save is achieved when both sides are detected with silence, since then the logical transport is removed, and no packets are transmitted over the air in a short interval. However, it was observed that this scenario occurs around 5%-25% of the time, while single side silence occurs with a much higher frequency of 25%-50% of the time (e.g. one side is talking, other listening). In this case it is useful to switch to empty packets but communicate to far end to generate comfort noise instead.

To request the far end to activate or stop comfort noise generation, protocol messages are sent between the Bluetooth devices. For example, AT commands may be used for classic Bluetooth HFP profile and stream/call control procedures are used in the Generic Audio Framework (GAF). GAF is currently developed as part of LE Audio specifications and may also apply to classic Bluetooth in the future.

FIG. 9 silence suppression negotiation flow. This figure summarizes the steps which are required from the Bluetooth voice profiles. The voice profile will monitor the silence suppression status as provided by the platform. When silence is detected in both directions: A to B and B to A, the profile control entities will negotiate silence suppression logical transport removal (S2LTR). The logical transport is then removed by the initiating profile, and the stream is in standby suppression state (generate comfort noise, locally in both ends). The profile entity continues monitoring the silence suppression state, and when silence is ended at either A or B, the profiles negotiate to reestablish the logical transport and resume streaming voice. When only single sided is detected, the profile control entity at the near end (where silence is detected) negotiates with the far end profile control entity to generate comfort noise and requests the profile data entity to stream zero-payload packets instead of audio packets over the air. When silence is no longer detected, the near end profile control entity negotiates with the far end profile control entity to stop comfort noise and requests the profile data entity to resume audio streaming over the air.

The ACL connection (in BR/EDR or LE) is never removed, even in the two-sided scenario, to allow silence->active transition control signaling, which are transmitted over the ACL connection. To ensure acceptable silence->active transition latency, the silence suppression entity will set an upper bound for the ACL sniff or LE ACL connection interval (a typical value would be around 50-100 ms).

Comfort noise played at the headset can be either locally generated or provided by the host. For local generation, the headset should take the audio content from the last N audio frames and play it in a continuous loop, using appropriate filters (e.g. raised cosine) to avoid discontinuities. As an alternative, the headset could use locally stored pre-provisioned comfort noise.

For host provided comfort noise, the host should send audio content to the headset as part of the connection setup process, for example by using a newly defined AT command.

FIG. 10 shows an example sequence chart of a case when 2-way silence is detected. In this example, a profile first detected one side silence and communicate it to the Bluetooth peer headset, which begin generating comfort noise. Later, also peer headset detected the silence condition, allowing to negotiate a removal of the audio logical transport (S2LTR). When silence condition ended, the audio logical transport is enabled, comfort noise stops and call audio continue streaming in both directions. FIGS. 9 and 10 exemplify the state machine and message sequences.

It is understood that the above descriptions are for purposes of illustration and are not meant to be limiting.

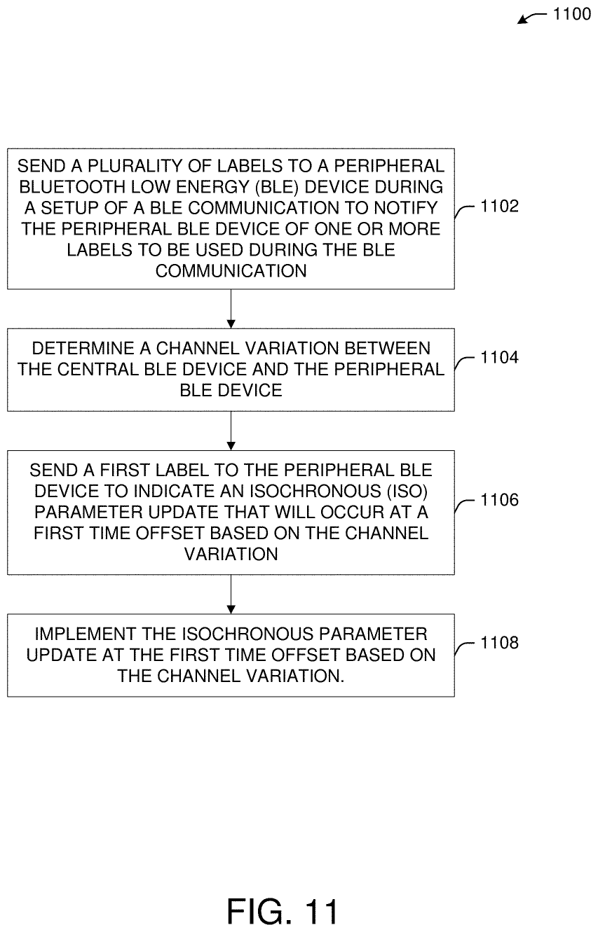

FIG. 11 illustrates a flow diagram of illustrative process 1100 for a label based isochronous connection update system, in accordance with one or more example embodiments of the present disclosure.

At block 1102, a device (e.g., the user device(s) 120 and/or the AP 102 of FIG. 1) may determine a first label associated with a first connected isochronous channels (CIS) connection.

At block 1104, the device may determine a frame comprising the first label.

At block 1106, the device may cause to send the frame to a first station device of one or more station devices.

It is understood that the above descriptions are for purposes of illustration and are not meant to be limiting.

FIG. 12 shows a functional diagram of an exemplary communication station 1200, in accordance with one or more example embodiments of the present disclosure. In one embodiment, FIG. 12 illustrates a functional block diagram of a communication station that may be suitable for use as an AP 102 (FIG. 1) or a user device 120 (FIG. 1) in accordance with some embodiments. The communication station 1200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1200 may include communications circuitry 1202 and a transceiver 1210 for transmitting and receiving signals to and from other communication stations using one or more antennas 1201. The communications circuitry 1202 may include circuitry that can operate the physical layer (PHY) communications and/or medium access control (MAC) communications for controlling access to the wireless medium, and/or any other communications layers for transmitting and receiving signals. The communication station 1200 may also include processing circuitry 1206 and memory 1208 arranged to perform the operations described herein. In some embodiments, the communications circuitry 1202 and the processing circuitry 1206 may be configured to perform operations detailed in the above figures, diagrams, and flows.

In accordance with some embodiments, the communications circuitry 1202 may be arranged to contend for a wireless medium and configure frames or packets for communicating over the wireless medium. The communications circuitry 1202 may be arranged to transmit and receive signals. The communications circuitry 1202 may also include circuitry for modulation/demodulation, upconversion/downconversion, filtering, amplification, etc. In some embodiments, the processing circuitry 1206 of the communication station 1200 may include one or more processors. In other embodiments, two or more antennas 1201 may be coupled to the communications circuitry 1202 arranged for sending and receiving signals. The memory 1208 may store information for configuring the processing circuitry 1206 to perform operations for configuring and transmitting message frames and performing the various operations described herein. The memory 1208 may include any type of memory, including non-transitory memory, for storing information in a form readable by a machine (e.g., a computer). For example, the memory 1208 may include a computer-readable storage device, read-only memory (ROM), random-access memory (RAM), magnetic disk storage media, optical storage media, flash-memory devices and other storage devices and media.

In some embodiments, the communication station 1200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1200 may include one or more antennas 1201. The antennas 1201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1200 may include one or more of a keyboard, a display, a non-volatile memory port, multiple antennas, a graphics processor, an application processor, speakers, and other mobile device elements. The display may be an LCD screen including a touch screen.

Although the communication station 1200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1200 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1200 may include one or more processors and may be configured with instructions stored on a computer-readable storage device.

FIG. 13 illustrates a block diagram of an example of a machine 1300 or system upon which any one or more of the techniques (e.g., methodologies) discussed herein may be performed. In other embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environments. The machine 1300 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a power management device 1332, a graphics display device 1310, an alphanumeric input device 1312 (e.g., a keyboard), and a user interface (UI) navigation device 1314 (e.g., a mouse). In an example, the graphics display device 1310, alphanumeric input device 1312, and UI navigation device 1314 may be a touch screen display. The machine 1300 may additionally include a storage device (i.e., drive unit) 1316, a signal generation device 1318 (e.g., a speaker), a label based isochronous connection update device 1319, a network interface device/transceiver 1320 coupled to antenna(s) 1330, and one or more sensors 1328, such as a global positioning system (GPS) sensor, a compass, an accelerometer, or other sensor. The machine 1300 may include an output controller 1334, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1302 for generation and processing of the baseband signals and for controlling operations of the main memory 1304, the storage device 1316, and/or the label based isochronous connection update device 1319. The baseband processor may be provided on a single radio card, a single chip, or an integrated circuit (IC).

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within the static memory 1306, or within the hardware processor 1302 during execution thereof by the machine 1300. In an example, one or any combination of the hardware processor 1302, the main memory 1304, the static memory 1306, or the storage device 1316 may constitute machine-readable media.

The label based isochronous connection update device 1319 may carry out or perform any of the operations and processes (e.g., process 1100) described and shown above.

It is understood that the above are only a subset of what the label based isochronous connection update device 1319 may be configured to perform and that other functions included throughout this disclosure may also be performed by the label based isochronous connection update device 1319.

While the machine-readable medium 1322 is illustrated as a single medium, the term “machine-readable medium” may include a single medium or multiple media (e.g., a centralized or distributed database, and/or associated caches and servers) configured to store the one or more instructions 1324.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1300 and that cause the machine 1300 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device/transceiver 1320 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1320 may include one or more physical jacks (e.g., Ethernet, coaxial, or phone jacks) or one or more antennas to connect to the communications network 1326. In an example, the network interface device/transceiver 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1300 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

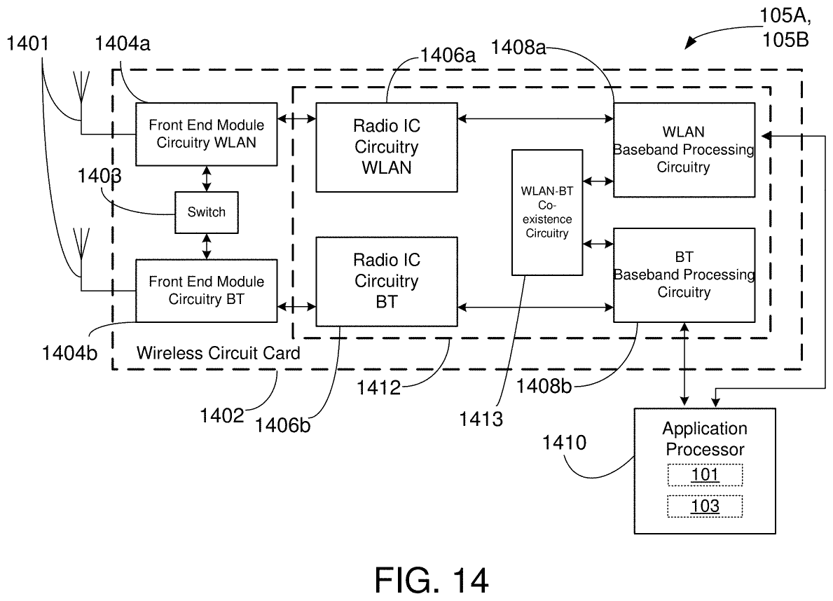

FIG. 14 is a block diagram of a radio architecture 105A, 105B in accordance with some embodiments that may be implemented in any one of the example AP 102 and/or the example STA 120 of FIG. 1. Radio architecture 105A, 105B may include radio front-end module (FEM) circuitry 1404a-b, radio IC circuitry 1406a-b and baseband processing circuitry 1408a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1404a-b may include a WLAN or Wi-Fi FEM circuitry 1404a and a Bluetooth (BT) FEM circuitry 1404b. The WLAN FEM circuitry 1404a may include a receive signal path comprising circuitry configured to operate on WLAN RF signals received from one or more antennas 1401, to amplify the received signals and to provide the amplified versions of the received signals to the WLAN radio IC circuitry 1406a for further processing. The BT FEM circuitry 1404b may include a receive signal path which may include circuitry configured to operate on BT RF signals received from one or more antennas 1401, to amplify the received signals and to provide the amplified versions of the received signals to the BT radio IC circuitry 1406b for further processing. FEM circuitry 1404a may also include a transmit signal path which may include circuitry configured to amplify WLAN signals provided by the radio IC circuitry 1406a for wireless transmission by one or more of the antennas 1401. In addition, FEM circuitry 1404b may also include a transmit signal path which may include circuitry configured to amplify BT signals provided by the radio IC circuitry 1406b for wireless transmission by the one or more antennas. In the embodiment of FIG. 14, although FEM 1404a and FEM 1404b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1406a-b as shown may include WLAN radio IC circuitry 1406a and BT radio IC circuitry 1406b. The WLAN radio IC circuitry 1406a may include a receive signal path which may include circuitry to down-convert WLAN RF signals received from the FEM circuitry 1404a and provide baseband signals to WLAN baseband processing circuitry 1408a. BT radio IC circuitry 1406b may in turn include a receive signal path which may include circuitry to down-convert BT RF signals received from the FEM circuitry 1404b and provide baseband signals to BT baseband processing circuitry 1408b. WLAN radio IC circuitry 1406a may also include a transmit signal path which may include circuitry to up-convert WLAN baseband signals provided by the WLAN baseband processing circuitry 1408a and provide WLAN RF output signals to the FEM circuitry 1404a for subsequent wireless transmission by the one or more antennas 1401. BT radio IC circuitry 1406b may also include a transmit signal path which may include circuitry to up-convert BT baseband signals provided by the BT baseband processing circuitry 1408b and provide BT RF output signals to the FEM circuitry 1404b for subsequent wireless transmission by the one or more antennas 1401. In the embodiment of FIG. 14, although radio IC circuitries 1406a and 1406b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1408a-b may include a WLAN baseband processing circuitry 1408a and a BT baseband processing circuitry 1408b. The WLAN baseband processing circuitry 1408a may include a memory, such as, for example, a set of RAM arrays in a Fast Fourier Transform or Inverse Fast Fourier Transform block (not shown) of the WLAN baseband processing circuitry 1408a. Each of the WLAN baseband circuitry 1408a and the BT baseband circuitry 1408b may further include one or more processors and control logic to process the signals received from the corresponding WLAN or BT receive signal path of the radio IC circuitry 1406a-b, and to also generate corresponding WLAN or BT baseband signals for the transmit signal path of the radio IC circuitry 1406a-b. Each of the baseband processing circuitries 1408a and 1408b may further include physical layer (PHY) and medium access control layer (MAC) circuitry, and may further interface with a device for generation and processing of the baseband signals and for controlling operations of the radio IC circuitry 1406a-b.

Referring still to FIG. 14, according to the shown embodiment, WLAN-BT coexistence circuitry 1413 may include logic providing an interface between the WLAN baseband circuitry 1408a and the BT baseband circuitry 1408b to enable use cases requiring WLAN and BT coexistence. In addition, a switch 1403 may be provided between the WLAN FEM circuitry 1404a and the BT FEM circuitry 1404b to allow switching between the WLAN and BT radios according to application needs. In addition, although the antennas 1401 are depicted as being respectively connected to the WLAN FEM circuitry 1404a and the BT FEM circuitry 1404b, embodiments include within their scope the sharing of one or more antennas as between the WLAN and BT FEMs, or the provision of more than one antenna connected to each of FEM 1404a or 1404b.

In some embodiments, the front-end module circuitry 1404a-b, the radio IC circuitry 1406a-b, and baseband processing circuitry 1408a-b may be provided on a single radio card, such as wireless radio card 1402. In some other embodiments, the one or more antennas 1401, the FEM circuitry 1404a-b and the radio IC circuitry 1406a-b may be provided on a single radio card. In some other embodiments, the radio IC circuitry 1406a-b and the baseband processing circuitry 1408a-b may be provided on a single chip or integrated circuit (IC), such as IC 1412.

In some embodiments, the wireless radio card 1402 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11 ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1408b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

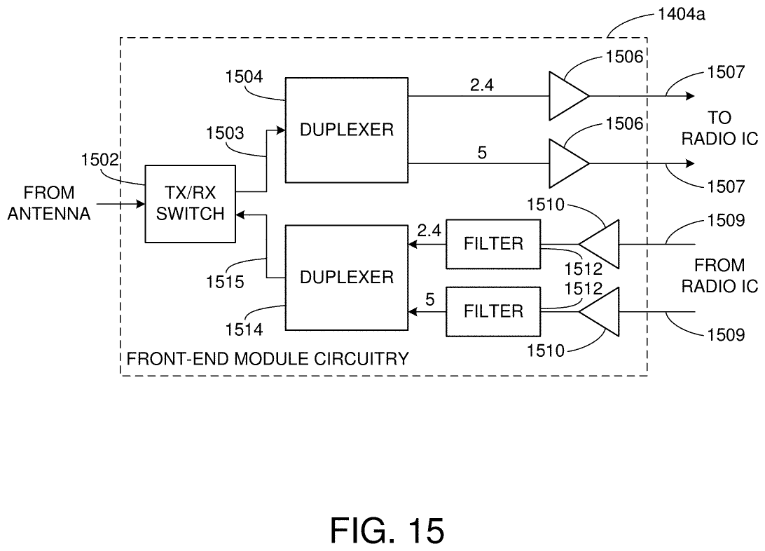

FIG. 15 illustrates WLAN FEM circuitry 1404a in accordance with some embodiments. Although the example of FIG. 15 is described in conjunction with the WLAN FEM circuitry 1404a, the example of FIG. 15 may be described in conjunction with the example BT FEM circuitry 1404b (FIG. 14), although other circuitry configurations may also be suitable.

In some embodiments, the FEM circuitry 1404a may include a TX/RX switch 1502 to switch between transmit mode and receive mode operation. The FEM circuitry 1404a may include a receive signal path and a transmit signal path. The receive signal path of the FEM circuitry 1404a may include a low-noise amplifier (LNA) 1506 to amplify received RF signals 1503 and provide the amplified received RF signals 1507 as an output (e.g., to the radio IC circuitry 1406a-b (FIG. 14)). The transmit signal path of the circuitry 1404a may include a power amplifier (PA) to amplify input RF signals 1509 (e.g., provided by the radio IC circuitry 1406a-b), and one or more filters 1512, such as band-pass filters (BPFs), low-pass filters (LPFs) or other types of filters, to generate RF signals 1515 for subsequent transmission (e.g., by one or more of the antennas 1401 (FIG. 14)) via an example duplexer 1514.

In some dual-mode embodiments for Wi-Fi communication, the FEM circuitry 1404a may be configured to operate in either the 2.4 GHz frequency spectrum or the 5 GHz frequency spectrum. In these embodiments, the receive signal path of the FEM circuitry 1404a may include a receive signal path duplexer 1504 to separate the signals from each spectrum as well as provide a separate LNA 1506 for each spectrum as shown. In these embodiments, the transmit signal path of the FEM circuitry 1404a may also include a power amplifier 1510 and a filter 1512, such as a BPF, an LPF or another type of filter for each frequency spectrum and a transmit signal path duplexer 1504 to provide the signals of one of the different spectrums onto a single transmit path for subsequent transmission by the one or more of the antennas 1401 (FIG. 14). In some embodiments, BT communications may utilize the 2.4 GHz signal paths and may utilize the same FEM circuitry 1404a as the one used for WLAN communications.

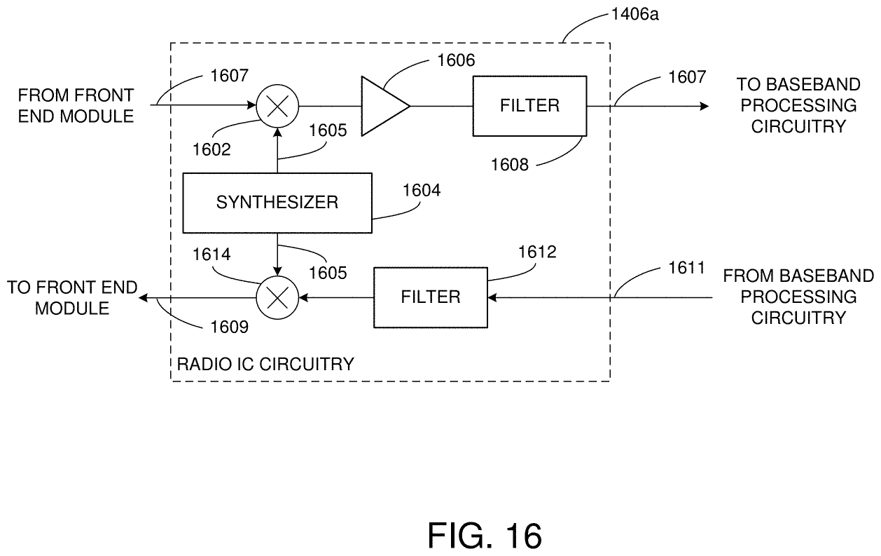

FIG. 16 illustrates radio IC circuitry 1406a in accordance with some embodiments. The radio IC circuitry 1406a is one example of circuitry that may be suitable for use as the WLAN or BT radio IC circuitry 1406a/1406b (FIG. 14), although other circuitry configurations may also be suitable. Alternatively, the example of FIG. 16 may be described in conjunction with the example BT radio IC circuitry 1406b.

In some embodiments, the radio IC circuitry 1406a may include a receive signal path and a transmit signal path. The receive signal path of the radio IC circuitry 1406a may include at least mixer circuitry 1602, such as, for example, down-conversion mixer circuitry, amplifier circuitry 1606 and filter circuitry 1608. The transmit signal path of the radio IC circuitry 1406a may include at least filter circuitry 1612 and mixer circuitry 1614, such as, for example, up-conversion mixer circuitry. Radio IC circuitry 1406a may also include synthesizer circuitry 1604 for synthesizing a frequency 1605 for use by the mixer circuitry 1602 and the mixer circuitry 1614. The mixer circuitry 1602 and/or 1614 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 16 illustrates only a simplified version of a radio IC circuitry, and may include, although not shown, embodiments where each of the depicted circuitries may include more than one component. For instance, mixer circuitry 1614 may each include one or more mixers, and filter circuitries 1608 and/or 1612 may each include one or more filters, such as one or more BPFs and/or LPFs according to application needs. For example, when mixer circuitries are of the direct-conversion type, they may each include two or more mixers.

In some embodiments, mixer circuitry 1602 may be configured to down-convert RF signals 1507 received from the FEM circuitry 1404a-b (FIG. 14) based on the synthesized frequency 1605 provided by synthesizer circuitry 1604. The amplifier circuitry 1606 may be configured to amplify the down-converted signals and the filter circuitry 1608 may include an LPF configured to remove unwanted signals from the down-converted signals to generate output baseband signals 1607. Output baseband signals 1607 may be provided to the baseband processing circuitry 1408a-b (FIG. 14) for further processing. In some embodiments, the output baseband signals 1607 may be zero-frequency baseband signals, although this is not a requirement. In some embodiments, mixer circuitry 1602 may comprise passive mixers, although the scope of the embodiments is not limited in this respect.

In some embodiments, the mixer circuitry 1614 may be configured to up-convert input baseband signals 1611 based on the synthesized frequency 1605 provided by the synthesizer circuitry 1604 to generate RF output signals 1509 for the FEM circuitry 1404a-b. The baseband signals 1611 may be provided by the baseband processing circuitry 1408a-b and may be filtered by filter circuitry 1612. The filter circuitry 1612 may include an LPF or a BPF, although the scope of the embodiments is not limited in this respect.

In some embodiments, the mixer circuitry 1602 and the mixer circuitry 1614 may each include two or more mixers and may be arranged for quadrature down-conversion and/or up-conversion respectively with the help of synthesizer 1604. In some embodiments, the mixer circuitry 1602 and the mixer circuitry 1614 may each include two or more mixers each configured for image rejection (e.g., Hartley image rejection). In some embodiments, the mixer circuitry 1602 and the mixer circuitry 1614 may be arranged for direct down-conversion and/or direct up-conversion, respectively. In some embodiments, the mixer circuitry 1602 and the mixer circuitry 1614 may be configured for super-heterodyne operation, although this is not a requirement.

Mixer circuitry 1602 may comprise, according to one embodiment: quadrature passive mixers (e.g., for the in-phase (I) and quadrature phase (Q) paths). In such an embodiment, RF input signal 1507 from FIG. 16 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1605 of synthesizer 1604 (FIG. 16). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1507 (FIG. 15) may comprise a balanced signal, although the scope of the embodiments is not limited in this respect. The I and Q baseband output signals may be provided to low-noise amplifier, such as amplifier circuitry 1606 (FIG. 16) or to filter circuitry 1608 (FIG. 16).

In some embodiments, the output baseband signals 1607 and the input baseband signals 1611 may be analog baseband signals, although the scope of the embodiments is not limited in this respect. In some alternate embodiments, the output baseband signals 1607 and the input baseband signals 1611 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1604 may be a fractional-N synthesizer or a fractional N/N+1 synthesizer, although the scope of the embodiments is not limited in this respect as other types of frequency synthesizers may be suitable. For example, synthesizer circuitry 1604 may be a delta-sigma synthesizer, a frequency multiplier, or a synthesizer comprising a phase-locked loop with a frequency divider. According to some embodiments, the synthesizer circuitry 1604 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1604 may be provided by a voltage controlled oscillator (VCO), although that is not a requirement. A divider control input may further be provided by either the baseband processing circuitry 1408a-b (FIG. 14) depending on the desired output frequency 1605. In some embodiments, a divider control input (e.g., N) may be determined from a look-up table (e.g., within a Wi-Fi card) based on a channel number and a channel center frequency as determined or indicated by the example application processor 1410. The application processor 1410 may include, or otherwise be connected to, one of the example secure signal converter 101 or the example received signal converter 103 (e.g., depending on which device the example radio architecture is implemented in).

In some embodiments, synthesizer circuitry 1604 may be configured to generate a carrier frequency as the output frequency 1605, while in other embodiments, the output frequency 1605 may be a fraction of the carrier frequency (e.g., one-half the carrier frequency, one-third the carrier frequency). In some embodiments, the output frequency 1605 may be a LO frequency (fLO).

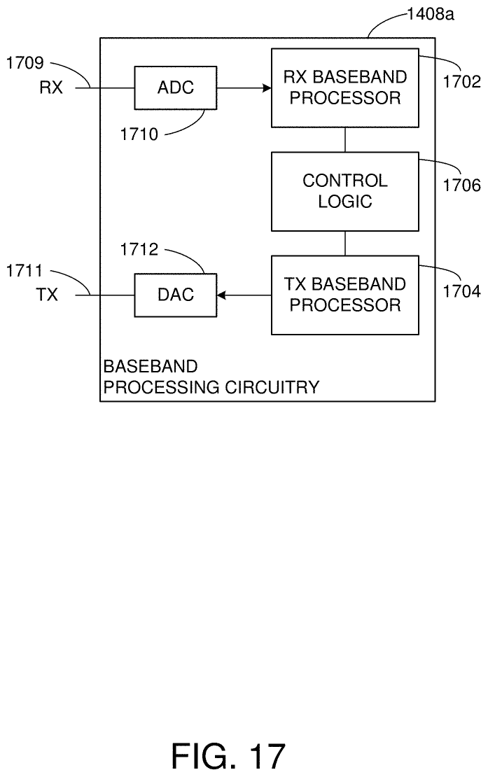

FIG. 17 illustrates a functional block diagram of baseband processing circuitry 1408a in accordance with some embodiments. The baseband processing circuitry 1408a is one example of circuitry that may be suitable for use as the baseband processing circuitry 1408a (FIG. 14), although other circuitry configurations may also be suitable. Alternatively, the example of FIG. 16 may be used to implement the example BT baseband processing circuitry 1408b of FIG. 14.

The baseband processing circuitry 1408a may include a receive baseband processor (RX BBP) 1702 for processing receive baseband signals 1609 provided by the radio IC circuitry 1406a-b (FIG. 14) and a transmit baseband processor (TX BBP) 1704 for generating transmit baseband signals 1611 for the radio IC circuitry 1406a-b. The baseband processing circuitry 1408a may also include control logic 1706 for coordinating the operations of the baseband processing circuitry 1408a.

In some embodiments (e.g., when analog baseband signals are exchanged between the baseband processing circuitry 1408a-b and the radio IC circuitry 1406a-b), the baseband processing circuitry 1408a may include ADC 1710 to convert analog baseband signals 1709 received from the radio IC circuitry 1406a-b to digital baseband signals for processing by the RX BBP 1702. In these embodiments, the baseband processing circuitry 1408a may also include DAC 1712 to convert digital baseband signals from the TX BBP 1704 to analog baseband signals 1711.

In some embodiments that communicate OFDM signals or OFDMA signals, such as through baseband processor 1408a, the transmit baseband processor 1704 may be configured to generate OFDM or OFDMA signals as appropriate for transmission by performing an inverse fast Fourier transform (IFFT). The receive baseband processor 1702 may be configured to process received OFDM signals or OFDMA signals by performing an FFT. In some embodiments, the receive baseband processor 1702 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 14, in some embodiments, the antennas 1401 (FIG. 14) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1401 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MIS 0) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

A central Bluetooth low energy (BLE) device, the device comprising processing circuitry coupled to storage, the processing circuitry configured to: send a plurality of labels to a peripheral BLE device during a setup of a BLE communication to notify the peripheral BLE device of one or more labels to be used during the BLE communication; determine a channel variation between the central BLE device and the peripheral BLE device; send a first label to the peripheral BLE device to indicate an isochronous (ISO) parameter update that will occur at a first time offset based on the channel variation; and implement the isochronous parameter update at the first time offset based on the channel variation.

Example 1 may include the device of example 1 and/or some other example herein, wherein each label comprises changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

Example 2 may include the device of example 1 and/or some other example herein, wherein the processing circuitry may be further configured to send an ISO protocol data unit (PDU) to the peripheral BLE device, wherein the ISO protocol data unit (PDU) comprises the first label.

Example 3 may include the device of example 3 and/or some other example herein, wherein the ISO PDU comprises a header, wherein the header comprises a header bit associated with a label field.

Example 4 may include the device of example 4 and/or some other example herein, wherein the header bit may be set to 1 to indicate a presence of the label field.

Example 5 may include the device of example 4 and/or some other example herein, wherein the header bit may be set to 0 to indicate an absence of the label field.

Example 6 may include the device of example 1 and/or some other example herein, wherein the first label may be 4 bits long.

Example 7 may include the device of example 1 and/or some other example herein, further comprising a transceiver configured to transmit and receive wireless signals.

Example 8 may include the device of example 8 and/or some other example herein, further comprising an antenna coupled to the transceiver to cause to send the first label.

Example 9 may include a non-transitory computer-readable medium storing computer-executable instructions which when executed by one or more processors of a central Bluetooth low energy (BLE) device result in performing operations comprising: sending a plurality of labels to a peripheral BLE device during a setup of a BLE communication to notify the peripheral BLE device of one or more labels to be used during the BLE communication; determining a channel variation between the central BLE device and the peripheral BLE device; sending a first label to the peripheral BLE device to indicate an isochronous (ISO) parameter update that will occur at a first time offset based on the channel variation; and implementing the isochronous parameter update at the first time offset based on the channel variation.

Example 10 may include the non-transitory computer-readable medium of example 10 and/or some other example herein, wherein each label comprises changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

Example 11 may include the non-transitory computer-readable medium of example 10 and/or some other example herein, wherein the operations further comprise sending an ISO protocol data unit (PDU) to the peripheral BLE device, wherein the ISO protocol data unit (PDU) comprises the first label.

Example 12 may include the non-transitory computer-readable medium of example 12 and/or some other example herein, wherein the ISO PDU comprises a header, wherein the header comprises a header bit associated with a label field.

Example 13 may include the non-transitory computer-readable medium of example 13 and/or some other example herein, wherein the header bit may be set to 1 to indicate a presence of the label field.

Example 14 may include the non-transitory computer-readable medium of example 13 and/or some other example herein, wherein the header bit may be set to 0 to indicate an absence of the label field.

Example 15 may include the non-transitory computer-readable medium of example 10 and/or some other example herein, wherein the first label may be 4 bits long.

Example 16 may include a method comprising: sending, by one or more processors of a central Bluetooth low energy (BLE) device, a plurality of labels to a peripheral BLE device during a setup of a BLE communication to notify the peripheral BLE device of one or more labels to be used during the BLE communication; determining a channel variation between the central BLE device and the peripheral BLE device; sending a first label to the peripheral BLE device to indicate an isochronous (ISO) parameter update that will occur at a first time offset based on the channel variation; and implementing the isochronous parameter update at the first time offset based on the channel variation.

Example 17 may include the method of example 17 and/or some other example herein, wherein each label comprises changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

Example 18 may include the method of example 17 and/or some other example herein, further comprising sending an ISO protocol data unit (PDU) to the peripheral BLE device, wherein the ISO protocol data unit (PDU) comprises the first label.

Example 19 may include the method of example 19 and/or some other example herein, wherein the ISO PDU comprises a header, wherein the header comprises a header bit associated with a label field.

Example 20 may include the method of example 20 and/or some other example herein, wherein the header bit may be set to 1 to indicate a presence of the label field.

Example 21 may include the method of example 20 and/or some other example herein, wherein the header bit may be set to 0 to indicate an absence of the label field.

Example 22 may include the method of example 17 and/or some other example herein, wherein the first label may be 4 bits long.

Example 23 may include an apparatus associated with a of a central Bluetooth low energy (BLE) device comprising means for: sending a plurality of labels to a peripheral BLE device during a setup of a BLE communication to notify the peripheral BLE device of one or more labels to be used during the BLE communication; determining a channel variation between the central BLE device and the peripheral BLE device; sending a first label to the peripheral BLE device to indicate an isochronous (ISO) parameter update that will occur at a first time offset based on the channel variation; and implementing the isochronous parameter update at the first time offset based on the channel variation.

Example 24 may include the apparatus of example 24 and/or some other example herein, wherein each label comprises changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

Example 25 may include the apparatus of example 24 and/or some other example herein, further comprising sending an ISO protocol data unit (PDU) to the peripheral BLE device, wherein the ISO protocol data unit (PDU) comprises the first label.

Example 26 may include the apparatus of example 26 and/or some other example herein, wherein the ISO PDU comprises a header, wherein the header comprises a header bit associated with a label field.

Example 27 may include the apparatus of example 27 and/or some other example herein, wherein the header bit may be set to 1 to indicate a presence of the label field.

Example 28 may include the apparatus of example 27 and/or some other example herein, wherein the header bit may be set to 0 to indicate an absence of the label field.

Example 29 may include the apparatus of example 24 and/or some other example herein, wherein the first label may be 4 bits long. Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A central Bluetooth low energy (BLE) device, the device comprising processing circuitry coupled to storage, the processing circuitry configured to:
send a plurality of labels to a peripheral BLE device during a setup of a BLE communication to notify the peripheral BLE device of one or more labels to be used during the BLE communication;
determine a channel variation between the central BLE device and the peripheral BLE device;
send a first label to the peripheral BLE device to indicate an isochronous (ISO) parameter update that will occur at a first time offset based on the channel variation; and
implement the isochronous parameter update at the first time offset based on the channel variation.

2. The central BLE device of claim 1, wherein each label comprises changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

3. The central BLE device of claim 1, wherein the processing circuitry is further configured to send an ISO protocol data unit (PDU) to the peripheral BLE device, wherein the ISO protocol data unit (PDU) comprises the first label.

4. The central BLE device of claim 3, wherein the ISO PDU comprises a header, wherein the header comprises a header bit associated with a label field.

5. The central BLE device of claim 4, wherein the header bit is set to 1 to indicate a presence of the label field.

6. The central BLE device of claim 4, wherein the header bit is set to 0 to indicate an absence of the label field.

7. The central BLE device of claim 1, wherein the first label is 4 bits long.

8. The central BLE device of claim 1, further comprising a transceiver configured to transmit and receive wireless signals.

9. The central BLE device of claim 8, further comprising an antenna coupled to the transceiver to cause to send the first label.

10. A non-transitory computer-readable medium storing computer-executable instructions which when executed by one or more processors of a central Bluetooth low energy (BLE) device result in performing operations comprising:
sending a plurality of labels to a peripheral BLE device during a setup of a BLE communication to notify the peripheral BLE device of one or more labels to be used during the BLE communication;
determining a channel variation between the central BLE device and the peripheral BLE device;
sending a first label to the peripheral BLE device to indicate an isochronous (ISO) parameter update that will occur at a first time offset based on the channel variation; and
implementing the isochronous parameter update at the first time offset based on the channel variation.

11. The non-transitory computer-readable medium of claim 10, wherein each label comprises changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

12. The non-transitory computer-readable medium of claim 10, wherein the operations further comprise sending an ISO protocol data unit (PDU) to the peripheral BLE device, wherein the ISO protocol data unit (PDU) comprises the first label.

13. The non-transitory computer-readable medium of claim 12, wherein the ISO PDU comprises a header, wherein the header comprises a header bit associated with a label field.

14. The non-transitory computer-readable medium of claim 13, wherein the header bit is set to 1 to indicate a presence of the label field.

15. The non-transitory computer-readable medium of claim 13, wherein the header bit is set to 0 to indicate an absence of the label field.

16. The non-transitory computer-readable medium of claim 10, wherein the first label is 4 bits long. A method comprising:
sending, by one or more processors a central Bluetooth low energy (BLE) device, a plurality of labels to a peripheral BLE device during a setup of a BLE communication to notify the peripheral BLE device of one or more labels to be used during the BLE communication;
determining a channel variation between the central BLE device and the peripheral BLE device;
sending a first label to the peripheral BLE device to indicate an isochronous (ISO) parameter update that will occur at a first time offset based on the channel variation; and
implementing the isochronous parameter update at the first time offset based on the channel variation.

18. The method of claim 17, wherein each label comprises changes to modulation, number of PHY, Burst Number (BN), Flush Timeout (FT), Number of Sub Events (NSE), ISO interval, Sub-Event Interval, Maximum protocol data unit (PDU) Size, or a transmit (TX) Power.

19. The method of claim 17, further comprising sending an ISO protocol data unit (PDU) to the peripheral BLE device, wherein the ISO protocol data unit (PDU) comprises the first label.

20. The method of claim 19, wherein the ISO PDU comprises a header, wherein the header comprises a header bit associated with a label field.
